(19) United States
(12) Patent Application Publication
(10) Pub. No.: US 2022/0261514 A1
(43) Pub. Date: Aug. 18, 2022

(54) SYSTEM OF DESIGNING SEISMIC ISOLATION MOUNT FOR PROTECTING ELECTRICAL EQUIPMENT COMPRISING SWITCHBOARD AND CONTROL PANEL

(71) Applicant: NASAN ELECTRIC INDUSTRIES CO., LTD., Changwon-si (KR)

(72) Inventors: Jong Hoon BAE, Changwon-si (KR); Su Hyeon SON, Changwon-si (KR); Seong Yong KIM, Changwon-si (KR); Sung Chun MOON, Gimhae-si (KR); Han Yeul AN, Gimhae-si (KR); Kyung Jin BAE, Changwon-si (KR)

(73) Assignee: NASAN ELECTRIC INDUSTRIES CO., LTD., Changwon-si (KR)

(21) Appl. No.: 17/251,330

(22) PCT Filed: Dec. 7, 2020
(86) PCT No.: PCT/KR2020/017772

§ 371 Date: Mar. 25, 2022

(30) Foreign Application Priority Data
May 8, 2020 (KR) 10-2020-0055188

(51) Int. Cl. G06F 30/20; H02B 1/54

(52) U.S. Cl. CPC G06F 30/20; G06F 2119/14; H02B 1/54

(57) ABSTRACT

Provided is a system of designing a seismic isolation mount for protecting electrical equipment comprising switchboard and control panel from earthquakes. The system of designing a seismic isolation mount includes: a user terminal for inputting design constants for physical properties and dimensions of protection target equipment; a database for storing design constants received from the user terminal; and a seismic isolation mount design server for determining a design variable satisfying a predetermined design condition on the basis of the design constants, in which the maximum bending stress is obtained as

$${σ}_{b , max} = {σ}_{b} ( ω ) {\vert}_{max} ≡ \frac{{dM}_{b , max}}{I} = \frac{d ( {F}_{max} L )}{I} = \frac{d ( kL \vert z ( t ) {\vert}_{max} )}{I} = \frac{{dmkLA}_{g} ( ω )}{2 ζ I} ( \frac{1}{{k}_{eq}} - \frac{1}{{k}_{s}} ) ,$$

and a spring constant and a damping constant of the seismic isolation mount are obtained as

$$\begin{matrix}{k}_{s} = \frac{{k •k}_{eq}}{k - {k}_{eq}} & ( N / m ) & if ( k - {k}_{eq} ) > 0 \\ {k}_{s} ≃ {k}_{eq} & ( N / m ) & if ( k - {k}_{eq} ) \leq 0\end{matrix}$$

$$and$$

$$\begin{matrix}{c}_{s} = \frac{{c•c}_{eq}}{c - {c}_{eq}} & ( Ns / m ) & if ( c - {c}_{eq} ) > 0 \\ {c}_{s} ≃ {c}_{eq} & ( Ns / m ) & if ( c - {c}_{eq} ) \leq 0\end{matrix} ,$$

respectively. According to the present disclosure, since it is possible to determine the spring constant and the damping constant of the seismic isolation mount in consideration of the physical properties of a protection target equipment, it is possible to design a seismic isolation mount customized for the protection target equipment and can effectively protect the protection target equipment from an earthquake.

### TECHNICAL FIELD

The present disclosure relates to seismic isolation equipment, particularly, to a system of designing seismic isolation mount for protecting electrical equipment comprising switchboard and control panel.

### BACKGROUND ART

Sense of crisis that Korea is no more a safe area against an earthquake is increasing due to the earthquakes that have recently occurred at Kyung-ju and Po-hang. In particular, since in-plate earthquakes such as the earthquake at Sichuan province more frequently occur, the possibility of a large-scale earthquake in Korea is increasing.

Although seismic design has been applied since laws on earthquake resistance was established in 1988 in Korea, the seismic ratio of the domestic buildings is not more than 6.8% up to now, so the structures are analyzed to be very vulnerable to earthquakes. The risk of an earthquake in cities has been greatly increased by the change of housing environment due to rapid urbanization and industrialization for the past 50 years, and according to the prediction model of damage due to earthquakes published by Ministry of Public Safety and Security, when a large-scale earthquake occurs at Seoul, KRW 427 trillion damage of buildings is estimated and KRW 536 trillion indirect damage is estimated, so huge damage is expected.

Accordingly, the Korean government has been strengthening the regulations on seismic design as a part of earthquake prevention measurements and is promoting seismic reinforcement measurements of the existing public facilities, so continuous growth of the seismic construction market is expected. In particular, as the damage due to earthquakes is increasing with the increase in world population and urbanization, the seismic technology is being highlighted as a future technology that can generate a high added value in the oversea construction markets.

In general, seismic design refers to structural design that determines the physical properties of a cross-section to keep all stresses in a structure is maintained within the allowable stress such that the structure can maintain safety and can exhibit its function when an earthquake occurs. The key point of the seismic design is to construct a building to correspond to the horizontal force of seismic waves. Recently, isolation design that minimizes transmission of vibration and vibration control design that offsets the shock of an earthquake by installing a damper in a structure are applied to seismic design.

At present, power supply facilities such as a relay panel, or facilities that are installed in a monitoring panel, a cabinet panel, a communication panel, a protection panel, a management room, a communication control line, a computer, and a control room, etc. are supposed to be installed on a double-floor system by installing another floor plate on the floor of a building. As for the configuration of the double-floor system, first, vertical supports are attached with regular intervals on a concrete slab floor by applying an epoxy adhesive and an installation floor plate is installed in a double layer over the floor slab with the vertical supports therebetween. Further, various facilities described above such as a relay panel or a switchboard are installed on the installation floor plate. When the relay panel, etc. are heavy, they are fixed by driving anchors in two of four holes in the installation floor plate, then cushion pads are placed over the heads, and then supports for fixing upper positions are connected and fixed by bolts around the vertical supports, thereby forming a frame. Then, top plates are assembled in all directions by fitting them in cushion pad grooves, thereby a double floor system is completed.

Referring to Korean Patent No. 10-1765683 (titled, “Two fracture type anchor assembly of and construction method using the same”), a two fracture type anchor assembly and an anchor installation method that can even absorb vibration of earthquake using the same has been disclosed. According to this method, two fracture type anchor assemblies each having an angle adjustment head that is installed at the front and rear ends of a PC steel strand and can adjust the installation angle of the PC steel strand absorbs vibration due to an earthquake or large-scale ground deformation and prevent bending of the PC steel strand due to tension, large-scale ground deformation, or an earthquake, whereby the PC steel strands can show maximum tension with the axial lines of force aligned under any condition.

However, such a two fracture type anchor assembly has a limit that it cannot be additionally installed unless it is installed in the step of construction, and it cannot be applied to existing facilities. That is, this technology could be applied to equipment or facilities to be newly installed, but suspension of power supply or movement is required to install a seismic reinforcement structure in equipment such as the existing switchboard or relay panel, so there is a problem that the technology cannot be applied due to equipment operation.

Accordingly, in order to improve the seismic performance of not only equipment to be newly installed, but also equipment already installed, a technology of designing a seismic isolation mount in consideration of the physical properties of corresponding facilities is needed.

### CITATION LIST

### Patent Literature

### Patent Literature 1

Korean Patent No. 10-1765683 (titled, “Two fracture type anchor assembly of and construction method using the same”)

### SUMMARY OF INVENTION

### Technical Problem

An objective of the present disclosure is to provide a system for designing a seismic isolation mount in consideration of the physical properties of protection target equipment to improve the seismic performance of the protection target equipment.

### Solution to Problem

In order to achieve the objectives of the present disclosure, a system of designing a seismic isolation part for protecting electrical equipment comprising switchboard and control panel includes: a user terminal for inputting design constants for physical properties and dimensions of protection target equipment; a database for storing design constants received from the user terminal; and a seismic isolation mount design server for determining a design variable satisfying a predetermined design condition on the basis of the design constants, in which the seismic isolation mount design server is configured to perform: an operation of configuring a vibration system model that models vibration of the protection target equipment in the horizontal direction; an operation of deriving a kinetic equation of the vibration system model and normalizing the kinetic equation; and an operation of determining a design variable for determining a spring constant and a damping coefficient of the seismic isolation mount that minimize the maximum bending stress and vibration transmissibility of the protection target equipment in the vibration system model. Further, the operation of configuring a vibration system model considers

Xₓ(ω)|ₘₐₓ≤δ_{s,a}: maximum spring displacement

X(ω)|ₘₐₓ≤δ_{x,a}: maximum relative displacement

Tₐ(ω)|ₘₐₓ≤T_{a, a}: maximum acceleration gain

σ_{b}(ω)|ₘₐₓ≤σₐ: maximum structural safety

to kₛ and cₛ that minimize f(ωₙ, ζ)= [symbol] σ_{b,max}+(1−ω)T_{a,max}
where σ_{δ}(ω)|ₘₐₓ is the maximum bending stress, σₐ is allowable stress, Tₐ(ω)|ₘₐₓ is the maximum acceleration gain, T_{a, a} is an acceleration gain limit, Xₛ(ω)|ₘₐₓ is the maximum spring displacement, δ_{s,a} is a spring displacement limit, X(ω)|ₘₐₓ is the maximum spring displacement, δ_{s,a} is a spring displacement limit X(ω)|ₘₐₓ is the maximum relative displacement, δ_{x,a} is displacement of a suspension device, and [symbol] is a weighting factor smaller than 1. In particular, the seismic isolation mount design server, in order to configure the vibration system model, considers the protection target equipment and the seismic isolation mount as columns vibrating in the direction, and uses intensive mass, a spring constant, and damping constant of each of the protection target equipment and the seismic isolation mount. Further, the seismic isolation mount design server models the kinetic equation as m\ddot{x}+c_{eq}\dot{x}+k_{eq}x=−mü_{g} to normalize the kinetic equation, and is configured to model the maximum acting force applied to the vibration system model as

$${F}_{max} ≃ {k}_{eq} X ( ω ) {\vert}_{max} = \frac{{k}_{eq} {A}_{g} ( {ω}_{n} )}{2 ζ {ω}_{n}^{2}} = \frac{m {A}_{g} ( {ω}_{n} )}{2 ζ} ,$$

is a natural frequency,

$${k}_{eq} = \frac{{k•k}_{s}}{k + {k}_{s}} , ζ = \frac{{c}_{eq}}{2 \sqrt{m {k}_{eq}}}$$

is a damping ratio, A_{g}(ω) is a ground acceleration spectrum,

$${c}_{eq} = \frac{{k•c}_{s}}{k + {k}_{s}} ,$$

k and kₛ are spring constants of the protection target equipment and the seismic isolation mount, respectively, c and cₛ are damping constants of the protection target equipment and the seismic isolation mount, respectively, and x is displacement in the direction. Further, the seismic isolation mount design server is configured to determine the spring constant and the damping coefficient of the seismic isolation mount in consideration of the maximum displacement limit values, acceleration gain limit values, and the maximum bending stress of the protection target equipment and the seismic isolation mount in order to determine the design variable. In particular, the maximum bending stress is obtained as

$${σ}_{b , max} = {σ}_{b} ( ω ) {\vert}_{max} = \frac{( {k}_{eq} X ( ω ) {\vert}_{w = {w}_{s}} L ) d}{I} = \frac{{k}_{eq} {LdA}_{g} ( {ω}_{n} )}{2 I ζ {ω}_{n}^{2}} ,$$

where d is the distance from the neutral axis to the outline of a cross-section of the protection target equipment, and L and I are the length and an area moment of inertia of the protection target equipment, respectively. Preferably, the seismic isolation mount design server obtains the spring constant and the damping coefficient of the seismic isolation mount as

$$\begin{matrix}{k}_{s} = \frac{{k •k}_{eq}}{k - {k}_{eq}} & ( N / m ) & if ( k - {k}_{eq} ) > 0 \\ {k}_{s} ≃ {k}_{eq} & ( N / m ) & if ( k - {k}_{eq} ) \leq 0\end{matrix}$$

$$and$$

$$\begin{matrix}{c}_{s} = \frac{{c•c}_{eq}}{c - {c}_{eq}} & ( Ns / m ) & if ( c - {c}_{eq} ) > 0 \\ {c}_{s} ≃ {c}_{eq} & ( Ns / m ) & if ( c - {c}_{eq} ) \leq 0\end{matrix}$$

in order to determine the design variable, and the seismic isolation mount design server uses at least one of an optimal algorithm, a meta-heuristic algorithm, and an Engineer's trial and error method for the design variable to determine the design variable. Further, the protection target equipment is at least one of a high-voltage switchboard, a low-voltage switchboard, a cabinet panel, a measurement control panel, and a motor control panel.

### Advantageous Effects of Invention

According to the present disclosure, since it is possible to determine the spring constant and the damping constant of the seismic isolation mount in consideration of the physical properties of a protection target equipment, it is possible to design a seismic isolation mount customized for the protection target equipment and can effectively protect the protection target equipment from a horizontal earthquake.

### BRIEF DESCRIPTION OF DRAWINGS

FIG. 1 is a block diagram schematically showing a system for designing a seismic isolation mount according to the present disclosure.

FIG. 2 is a flowchart schematically showing a method that is performed in the system for designing a seismic isolation mount shown in FIG. 1.

FIGS. 3 and 4 show an example of a damping vibration system model considered in the system for designing a seismic isolation mount shown in FIG. 1.

FIG. 5 shows the dimensions of an equivalent column.

FIG. 6 shows an example of obtaining design variables using the present disclosure.

### DESCRIPTION OF EMBODIMENTS

It is required to refer to the accompanying drawings exemplifying preferred embodiments of the present disclosure and the contents in the accompanying drawings to help sufficiently understand the present disclosure, the operational advantages of the present disclosure, and the objects that are achieved by implementing the present disclosure.

The present disclosure will be described hereafter in detail by describing exemplary embodiments of the present disclosure with reference to the accompanying drawings. However, the present disclosure may be modified in various different ways and is not limited to the embodiments described herein. Parts that are not related to the description are omitted to make the present disclosure clear, and the same components are given the same reference numerals.

The term ‘protection target equipment’ used throughout the specification is a name including electrical equipment including a switchboard, a control panel, etc. and is used together with them.

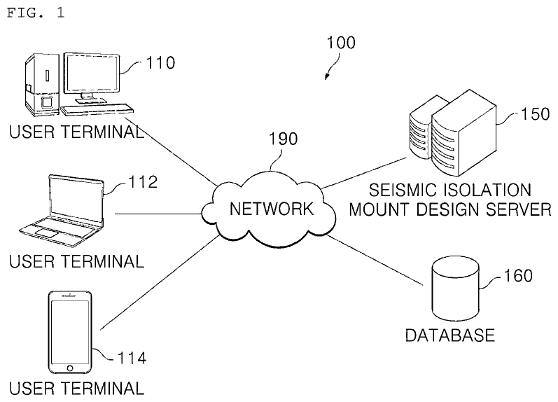

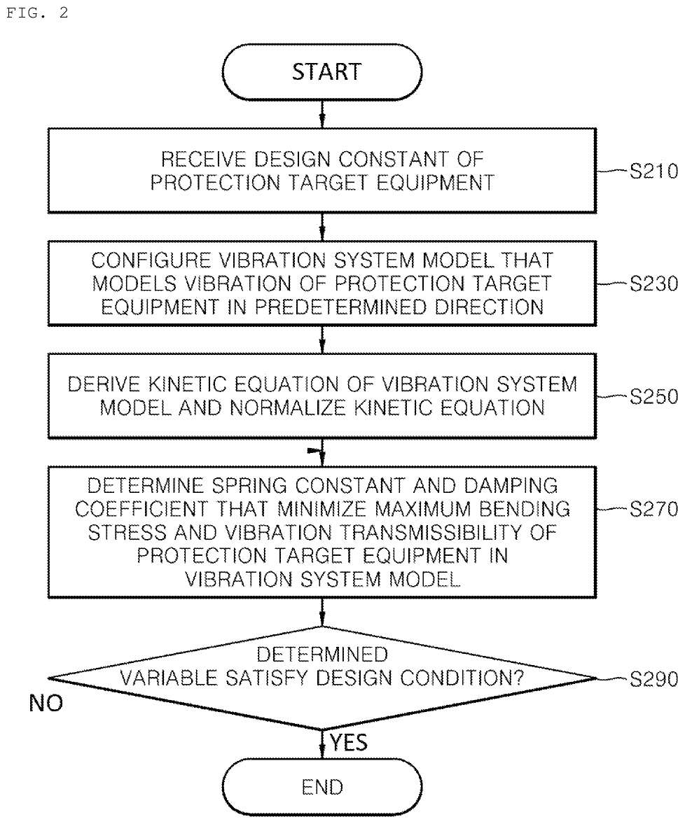

FIG. 1 is a block diagram schematically showing a system for designing a seismic isolation mount according to the present disclosure, and FIG. 2 shows an example of a method that is performed in the system shown in FIG. 1.

Referring to FIG. 1, a system for designing a seismic isolation mount according to the present disclosure includes user terminals 110, 112, and 114, a seismic isolation mount design server 150, and a database 160.

The user terminals 110, 112, and 114 are used to input design constants such as physical properties and dimensions of protection target equipment, and receive design variables determined by the seismic isolation mount design server 150. The design constants input through the user terminals 110, 112, and 114 are transmitted to the seismic isolation mount design server 150 through a network 190 and stored in the database 160.

The seismic isolation mount design server 150 includes a processor that can implement the method described with reference to FIG. 1. The design variables determined by the seismic isolation mount design server 150 are transmitted back to the user terminals 110, 112, and 114 through the network 190. The method that is performed in the seismic isolation mount design server 150 will be described below with reference to FIG. 2.

FIG. 2 is a flowchart schematically showing a method that is performed in the system for designing a seismic isolation mount shown in FIG. 1.

The method of designing a seismic isolation mount includes: receiving design constants such as physical dimensions and properties of protection target equipment (S210); configuring a vibration system model that models vibration of the protection target equipment in a predetermined direction (S230); deriving a kinetic equation of the vibration system model and normalizing the kinetic equation (S250); and determining a spring constant and a damping coefficient of the seismic isolation mount that minimize the maximum bending stress and vibration transmission rate of the protection target model in the vibration system model (S270). Further, the method includes determining whether the determined design variables satisfy the design, and when not, determining again and refining design variables (S290). The steps will be described below at corresponding parts in the specification.

Hereafter, a method that is performed in the system for designing a seismic isolation mount according to the present disclosure will be described in detail.

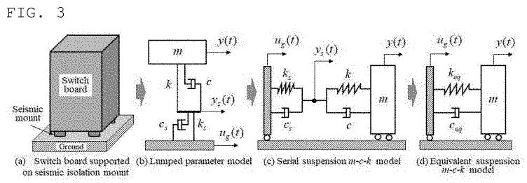

FIGS. 3 and 4 show a 1-DOF (degree of freedom) vibration system model for seismic analysis when a switchboard supported on a seismic isolation mount receives an earthquake motion in a predetermined direction. In the modeling of FIG. 3, m is the mass of a switchboard considered as intensive mass, and k and c are respectively a spring constant and damping constant when the switchboard structures are considered as cantilever columns. Further, kₛ, cₛ are a spring constant and a damping constant of the seismic isolation mount when the seismic isolation mount is considered as a column having elasticity and damping ability.

Further U_{g}(t) is displacement of the ground, y(t) is vibration displacement of the switchboard, and yₛ(t) is displacement of the top of the seismic isolation mount. In the modeling of FIG. 3, the spring constant k is the bending strength of the switchboard approximated to a column, so if the switchboard is the same as the switchboard of FIG. 4, the spring constant of the column is

$$k = \frac{3 EI}{{L}^{3}} .$$

### Kinetic Equation

A kinetic equation for the mathematical model of FIG. 3D is derived using Newton's laws of motion and then expressed with respect to relative replacement x(t)=y(t)−u_{g}(t), which is as follows.

m\ddot{x}+c_{eq}\dot{x}+k_{eq}x=−mü_{g} [Formula 1]

where k_{eq} that is an equivalent spring constant and c_{eq} that is an equivalent damping coefficient can be obtained from the mathematical model of FIG. 3, respectively as follows.

$${k}_{eq} = \frac{{k•k}_{s}}{k + {k}_{s}} and {c}_{eq} = \frac{{c•c}_{s}}{c + {c}_{s}} \qquad [ Formula 2 ]$$

However, as it is c<<cₛ in the switchboards of most seismic isolation mounts, the model of FIG. 3C becomes a Zener model, as in FIG. 4A.

FIG. 4A is a so-called Zener model that is a non-linear viscoelastic suspension model composed of two springs and one damper. In FIG. 4, the relationship between the acting force F and the displacement x=y−u_{g} (or stress and strain) is non-linear, but is expressed as a linear function using Tailor's series development as follows.

$$F + {τ}_{f} \frac{d F}{d t} = {M}_{r} ( x + {τ}_{x} + \frac{dx}{dt} ) \qquad [ Formula 3 ]$$

where τ_{f}·τₓ are relaxation times given by the following Formula 4, and M_{TM}_{ᵣ} is a relaxed modulus given by Formula 5.

$${T}_{f} = \frac{{c}_{s}}{k + {k}_{s}} , {τ}_{x} = \frac{{c}_{s}}{{k}_{s}} \qquad [ Formula 4 ]$$

$${M}_{r} = \frac{{k•k}_{s}}{k + {k}_{s}} \qquad [ Formula 5 ]$$

In formula 4, since it is cₛ<<(k+kₛ) for a switchboard supported on a seismic isolation mount, τ_{f}≃0.

Accordingly, by substituting Formula 4 and Formula 3 in Formula 3 and arranging, the following formula is obtained.

$$F = \frac{k \cdot {k}_{s}}{k + {k}_{s}} ( x + \frac{{c}_{s}}{{k}_{s}} \frac{dx}{dt} ) = \frac{k \cdot {k}_{s}}{k + {k}_{s}} x + \frac{k \cdot {c}_{s}}{k + {k}_{s}} \dot{x} \qquad [ Formula 6 ]$$

Meanwhile, the relationship between an acting force and displacement in the equivalent spring-damper suspension device of FIG. 4B can be expressed as the following formula.

F=k_{eq}x+c_{eq}\dot{x} [Formula 7]

Comparing Formula 7 and Formula 6, the equivalent spring constant and the equivalent damping coefficient of the suspension device of the Zener model become as follows.

$${k}_{eq} = \frac{k \cdot {k}_{s}}{k + {k}_{s}} and {c}_{eq} = \frac{k \cdot {c}_{s}}{k + {k}_{s}} \qquad [ Formula 8 ]$$

Accordingly, the kinetic equation for the model of FIG. 4B is obtained by applying the equivalent spring constant and the equivalent damping coefficient of Equation 8 to kinetic equation of Formula 1, and it can be expressed as follows through normalization.

\ddot{x}+2ζωₙ\dot{x}+ωₙ²x=−ü_{g} [Formula 9]

In Formula 9,

$${ω}_{m} = \sqrt{\frac{{k}_{eq}}{m}}$$

is a natural frequency,

$${k}_{eq} = \frac{k \cdot {k}_{s}}{k + {k}_{s}} , ζ = \frac{{c}_{eq}}{2 \sqrt{{mk}_{eq}}}$$

is a damping ratio, and

$${c}_{eq} = \frac{k \cdot {c}_{s}}{k + {k}_{s}} .$$

### Frequency Responses

Assuming ground displacement u_{g}(t), vibration displacement y(t) of a switchboard, relative vibration displacement response of a base excitation vibration system x(t)=y(t)−u_{g}(t), displacement of a seismic isolation mount yₛ(t), and relative displacement of a seismic isolation mount xₛ(t)=yₛ(t)−u_{g}(t) are harmonic vibration as follows

u_{g}(t)=U_{g}(ω)e^{iut} [Formula 10]

y(t)=Y(ω)e^{iut} [Formula 11]

x(t)=X(ω)e^{iut} [Formula 12]

yₛ(t)=Yₛ(ω)e^{iut} [Formula 13]

xₛ(t)=Xₛ(ω)e^{iut} [Formula 14]

are obtained. Ground acceleration ü_{g}(t), vibration displacement response ÿ(t) of a switchboard, relative acceleration response \ddot{x}(t) of the switchboard, acceleration response ÿs(t) of a seismic isolation mount, and relative acceleration response \ddot{x}s(t) of the seismic isolation mount can be expressed as follows.

\ddot{u}_{g}(t)=−ω²U_{g}(ω)e^{iut}=A_{g}(ω)e^{iut} [Formula 15]

\ddot{y}(t)=−ω²Y(ω)e^{iut}=A_{y}(ω)e^{iut} [Formula 16]

\ddot{x}(t)=−ω²X(ω)e^{iut}=A(ω)e^{iut} [Formula 17]

\ddot{y}ₛ(t)=−ω²Yₛ(ω)e^{iut}=A_{sy}(ω)e^{iut} [Formula 18]

\ddot{x}ₛ(t)=−ω²Xₛ(ω)e^{iut}=Aₛₓ(ω)e^{iut} [Formula 19]

If a ground acceleration spectrum A_{g}(ω) is given, it is possible to obtain relative vibration displacement frequency response x(ω) as follows by obtaining the solution of Formula 9 that is vibration system kinetic equation using a transfer function method.

$$X ( ω ) = \frac{{A}_{g} ( ω )}{\sqrt{( {ω}_{n}^{2} - {ω}^{2} ) + {( 2 ζ {ω}_{n} ω )}^{2}}} = \frac{- {ω}^{2} {U}_{g} ( ω )}{\sqrt{( {ω}_{n}^{2} - {ω}^{2} ) + {( 2 ζ {ω}_{n} ω )}^{2}}} = \frac{{r}^{2} {U}_{g} ( ω )}{\sqrt{( 1 - {r}^{2} ) + {( 2 ζ r )}^{2}}} \qquad [ Formula 20 ]$$

In Formula 20, r=ω/ωₙ is a frequency ratio,

$${ω}_{n} = \sqrt{\frac{{k}_{eq}}{m}}$$

is a natural frequency,

$${k}_{eq} = \frac{k \cdot {k}_{s}}{k + {k}_{s}} , and ζ = \frac{{c}_{eq}}{2 \sqrt{{mk}_{eq}}}$$

is a damping ratio.

$${c}_{eq} = \frac{k \cdot {c}_{s}}{k + {k}_{s}} .$$

Further, the maximum relative displacement X(ω)|ₘₐₓ of the switchboard can be obtained from the above formula as follows.

$$X ( ω ) {\vert}_{max} ≃ X ( ω ) {\vert}_{ω = {ω}_{n}} = \frac{{A}_{g} ( ω )}{2 {ζω}_{n}^{2}} \qquad [ Formula 21 ]$$

Meanwhile, the relative displacement of the seismic isolation mount in the switchboard vibration system model of FIG. 4A is defined as follows

xₛ(t)≡yₛ(t)−u_{g}(t) [Formula 22]

The maximum relative displacement Xₛ(ω)|ₘₐₓ of the seismic isolation mount can be expressed as follows by applying Formulae 10, 13, and 14 to Formula 22.

Xₛ(ω)|ₘₐₓ=|Yₛ(ω)−U_{g}(ω)|ₘₐₓ [Formula 23]

### Displacement, Velocity, Acceleration Spectral Responses

If a ground motion ü_{g}(t) is given in the kinetic equation of Formula 9, the relative displacement x(t) of a switchboard vibration system can be obtained as follows by applying superposition integration.

$$x ( t ) = - \frac{1}{{ω}_{d}} {\int }_{0}^{t} {\ddot{u}}_{g} ( t ) {e}^{- ( {ω}_{n} ( t - τ )} sin {ω}_{d} ( t - τ ) d τ , \qquad [ Formula 24 ]$$

where ω_{d}=\sqrt{1−ζ²}ωₙ is a damped natural frequency. The maximum absolute value of the displacement response x(t) obtained by searching the analyzed time period, that is, |x(t)|ₘₐₓ, is defined as “spectral displacement of the system” S_{d}(ωₙζ) in seismic analysis of a vibration system. That is,

S_{d}(ωₙ, ζ)≡|x(t)|ₘₐₓ=max(|x(t)|) [Formula 25]

Further, spectral velocity Sᵥ(ωₙ, ζ) and spectral acceleration Sₐ(ωₙ, ζ) of seismic analysis of a vibration system are defined as follows, respectively.

Sᵥ(ωₙ, ζ)=|\dot{x}(t)|ₘₐₓ≃ωₙ|x(t)|ₘₐₓ=ωₙS_{d} [Formula 26]

i Sₐ(ωₙ, ζ)=|\ddot{x}(t)|ₘₐₓ≃ωₙ²|x(t)|ₘₐₓ=ωₙ²S_{d} [Formula 27]

Assuming that |x(t)| obtained through response spectrum method seismic analysis is proximately the same as the maximum value of frequency response X(ω) of a base excitation system obtained by harmonic analysis method of Formula 20, proximate displacement-, velocity-, acceleration-, and spectral responses of seismic analysis for the vibration system of FIG. 4B are obtained as follows, respectively.

\tilde{S}_{d}(ωₙ, ζ)=X(ω)|ₘₐₓ≃|x(t)|ₘₐₓ=S_{d}(ωₙ, ζ)tm [Formula 28]

\tilde{S}ᵥ(ωₙ, ζ)=ωₙX(ω|ₘₐₓ=ωₙ\tilde{S}_{d} [Formula 29]

\tilde{S}ₐ(ωₙ,ζ)=ωₙ²X(ω)|ₘₐₓ=ωₙ²\tilde{S}_{d} [Formula 30]

### Maximum Bending Deformation and Bending Stress, and Structural Safety Ratio of Switchboard Structure

The maximum force applied to switchboard mass m in the switchboard vibration system model of FIG. 4B is as follows.

Fₘₐₓ=k_{eq}|x(t)|ₘₐₓ=m|\ddot{x}(t)|ₘₐₓ=mSₐ [Formula 31]

The above formula becomes as follows using proximate spectral response.

Fₘₐₓ≃k_{eq}X(ω)|ₘₐₓ=m(ω²X(ω)|ₘₐₓ=m\tilde{S}ₐ [Formula 32]

Substituting the maximum relative displacement X(ω)|ₘₐₓ obtained in Formula 21 into the above formula, the maximum acting force Fₘₐₓ applied to the mass m in the seismic isolation mount-switchboard vibration system is obtained as follows.

$${F}_{max} ≃ {k}_{eq} X ( ω ) {\vert}_{max} = \frac{{k}_{eq} {A}_{g} ( {ω}_{n} )}{2 ζ {ω}_{n}^{2}} = \frac{{mA}_{g} ( {ω}_{n} )}{2 ζ} where {ω}_{n} = \sqrt{\frac{{k}_{eq}}{m}} \qquad [ Formula 33 ]$$

is a natural frequency,

$${k}_{eq} = \frac{k \cdot {k}_{s}}{k + {k}_{s}} , ζ = \frac{{c}_{eq}}{2 \sqrt{{mk}_{eq}}}$$

is a damping ratio, and

$${k}_{eq} = \frac{k \cdot {k}_{s}}{k + {k}_{s}} .$$

Meanwhile, the following relationship is obtained from the relationship of force applied to a series spring and displacement in a vibration system.

$${Y}_{s} ( ω ) - {U}_{g} ( ω ) = \frac{{F}_{max}}{{k}_{s}} \qquad [ Formula 34 ]$$

$$Y ( ω ) - {Y}_{s} ( ω ) = \frac{{F}_{max}}{k} \qquad [ Formula 35 ]$$

$$Y ( ω ) - {U}_{g} ( ω ) = \frac{{F}_{max}}{{k}_{eq}} \qquad [ Formula 36 ]$$

In the above formulae, Fₘₐₓ is the maximum acting force that acts on the mass m in the seismic isolation mount-switchboard vibration system, kₛ is a spring constant in a seismic isolation mount, k is a spring constant in a switchboard (structure), and k_{eq} is an equivalent spring constant in a vibration system, which is a spring constant when kₛ and k are connected in series.

The maximum relative displacement Xₛ(ω)|ₘₐₓ seismic isolation mount becomes as follows by applying the relationship of Formula 34 and Formula 36 to Formula 23.

$${{X}_{s} ( ω ) \vert}_{max} = \vert {Y}_{s} ( ω ) - {U}_{g} ( ω ) \vert = \frac{{F}_{max}}{{k}_{s}} \qquad [ Formula 37 ]$$

Substituting the maximum acting force Fₘₐₓ acting on the mass m in the seismic isolation mount-switchboard vibration system obtained in Formula 33 into Formula 37, the maximum relative displacement Xₛ(ω)|ₘₐₓ of the seismic isolation mount is consequently obtained as follows.

$$[ Formula 38 ]$$

$${{X}_{s} ( ω ) \vert}_{max} = \vert {Y}_{s} ( ω ) - {U}_{g} ( ω ) \vert = \frac{{F}_{max}}{{k}_{s}} = \frac{{k}_{eq} {A}_{g} ( {ω}_{n} )}{2 ζ {k}_{s} {ω}_{n}^{2}} = \frac{m {A}_{g} ( {ω}_{n} )}{2 ζ {k}_{s}}$$

$$where {ω}_{n} = \sqrt{\frac{{k}_{eq}}{m}}$$

is a natural frequency,

$${k}_{eq} = \frac{k \cdot {k}_{s}}{k + {k}_{s}} , ζ = \frac{{c}_{eq}}{2 \sqrt{{mk}_{eq}}}$$

is a damping ratio, and

$${c}_{eq} = \frac{k \cdot {c}_{s}}{k + {k}_{s}} .$$

Since the bending deformation of a switchboard structure (column) due to the acting force of a switchboard is z(t)≡y(t)−yₛ(t), the maximum value |z(t)|ₘₐₓ=Z(ω)|ₘₐₓ of bending deformation is obtained as follows.

Z(ω)|ₘₐₓ=|Y(ω)−Yₛ(ω)|ₘₐₓ=X(ω)|ₘₐₓ−Xₛ(ω)|ₘₐₓ [Formula 39]

The maximum bending deformation Z(ω)|ₘₐₓ of a switchboard structure (column) is obtained as follows by substituting Formulae 21 and 38 into Formula 39.

$${{Z ( ω ) \vert}_{max} \approx Z ( ω ) \vert}_{ω = {ω}_{n}} = \frac{m {A}_{g} ( {ω}_{n} )}{2 ζ} ( \frac{1}{{k}_{eq}} - \frac{1}{{k}_{s}} ) \qquad [ Formula 40 ]$$

$$where {ω}_{n} = \sqrt{\frac{{k}_{eq}}{m}}$$

is a natural frequency,

$${k}_{eq} = \frac{k \cdot {k}_{s}}{k + {k}_{s}} , ζ = \frac{{c}_{eq}}{2 \sqrt{{mk}_{eq}}}$$

is a damping ratio, and

$${c}_{eq} = \frac{k \cdot {c}_{s}}{k + {k}_{s}} .$$

The maximum shear force applied to the switchboard structure (column) is as follows.

$$[ Formula 41 ]$$

$${{F}_{max} = k {\vert z ( t ) \vert}_{max} \approx k \cdot Z ( ω ) \vert}_{max} = \frac{{mkA}_{g} ( ω )}{2 ζ} ( \frac{1}{{k}_{eq}} - \frac{1}{{k}_{s}} ) \\ where {ω}_{n} = \sqrt{\frac{{k}_{eq}}{m}}$$

is a natural frequency,

$${k}_{eq} = \frac{k \cdot {k}_{s}}{k + {k}_{s}} , and ζ = \frac{{c}_{eq}}{2 \sqrt{{mk}_{eq}}}$$

is a damping ratio. Therefore, the maximum bending moment generated in the switchboard structure (column) is obtained as follows.

$$[ Formula 42 ]$$

$${M}_{b , max} = {F}_{max} L = kL {\vert z ( t ) \vert}_{max} = \frac{{mkLA}_{g} ( ω )}{2 ζ} ( \frac{1}{{k}_{eq}} - \frac{1}{{k}_{s}} ) \\ where {ω}_{n} = \sqrt{\frac{{k}_{eq}}{m}}$$

is a natural frequency,

$${k}_{eq} = \frac{k \cdot {k}_{s}}{k + {k}_{s}} , ζ = \frac{{c}_{eq}}{2 \sqrt{{mk}_{eq}}}$$

is a damping ratio, and

$${c}_{eq} = \frac{k \cdot {c}_{s}}{k + {k}_{s}} .$$

The maximum bending stress generated in a switchboard structure (column) is defined from the bending deformation theory of a beam (column) as follows.

$$\begin{matrix}{{σ}_{b , max} = {σ}_{b} ( ω ) \vert}_{max} ≡ \frac{{dM}_{b , max}}{I} = \frac{d ( {F}_{max} L )}{I} \\ = \frac{d ( kL {\vert z ( t ) \vert}_{max} )}{I} = \frac{{dmkLA}_{g} ( ω )}{2 ζ I} ( \frac{1}{{k}_{eq}} - \frac{1}{{k}_{s}} )\end{matrix} \qquad [ Formula 43 ]$$

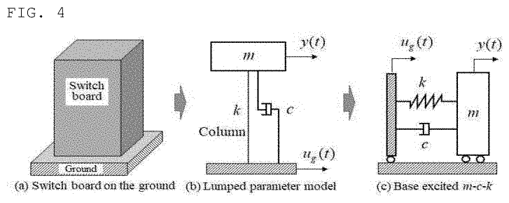

In Formula 43, M_{b,max} is the maximum bending moment acting in a structure (column), and d is, as shown in FIG. 5, the distance from the neutral axis to the outline of a cross-section of a column. L and I are the length and an area moment of inertia of the column, respectively. Further,

$${ω}_{n} = \sqrt{\frac{{k}_{eq}}{m}}$$

is a natural frequency,

$${k}_{eq} = \frac{k \cdot {k}_{s}}{k + {k}_{s}} , ζ = \frac{{c}_{eq}}{2 \sqrt{{mk}_{eq}}}$$

is a damping ratio, and

$${c}_{eq} = \frac{k \cdot {c}_{s}}{k + {k}_{s}} .$$

A structural safety factor S can be obtained as follows by comparing the maximum bending stress obtained in Formula 43 and the allowable stress of a column material.

$$S = \frac{σ}{{σ}_{b , max}} \qquad [ Formula 44 ]$$

where σₐ is the allowable stress of a column, that is, a switchboard structure material.

### Displacement Gain and Acceleration Gain

In the seismic theory of a base excitation vibration system of FIG. 4B, a displacement gain or a displacement transmissibility T_{d}(ω) is defined as the ratio of a switchboard displacement amplitude Y(ω) to a ground displacement amplitude U_{g}(ω). Similarly, an acceleration gain or an acceleration transmissibility Tₐ(ω) is defined as the ratio of a switchboard acceleration response amplitude A_{y}(ω) to a ground acceleration amplitude A_{g}(ω). A displacement gain T_{d}(ω) and an acceleration gain Tₐ(ω) can be obtained as follows by substituting the relationship of X(ω)=Y(ω)−U_{g}(ω) into the switchboard relative displacement response X(ω) obtained from Formula 20.

$${T}_{d} ( ω ) = \frac{Y ( ω )}{{U}_{g}} = \sqrt{\frac{1 + {( 2 ζ r )}^{2}}{( 1 - {r}^{2} ) + {( 2 ζ r )}^{2}}} \\ {T}_{a} ( ω ) = \frac{{A}_{y} ( ω )}{{A}_{g}} = \sqrt{\frac{1 + {( 2 ζ r )}^{2}}{( 1 - {r}^{2} ) + {( 2 ζ r )}^{2}}} = {T}_{d} \qquad [ Formula 45 ]$$

where r'ω/ωₙ a frequency ratio,

$${ω}_{n} = \sqrt{\frac{{k}_{eq}}{m}}$$

is a natural frequency,

$${k}_{eq} = \frac{k \cdot {k}_{s}}{k + {k}_{s}} , ζ = \frac{{c}_{eq}}{2 \sqrt{{mk}_{eq}}}$$

is a damping ratio, and

$${c}_{eq} = \frac{k \cdot {c}_{s}}{k + {k}_{s}} .$$

As for fine damping, the maximum displacement gain T_{d}(ω)|ₘₐₓ and the maximum acceleration gain Tₐ9ω)|ₘₐₓ can be obtained from Formula 45 as follows.

$${{{{T}_{d} ( ω ) \vert}_{max} ≃ {T}_{d} ( ω ) \vert}_{r = 1} = \frac{\sqrt{1 + {( 2 ζ )}^{2}}}{2 ζ} ≃ \frac{1 + 2 {ζ}^{2}}{2 ζ} = {T}_{a} ( ω ) \vert}_{max} where ζ = \frac{{c}_{eq}}{2 \sqrt{{mk}_{eq}}} \qquad [ Equation 46 ]$$

is a damping ratio, and

$${c}_{eq} = \frac{k \cdot {c}_{s}}{k + {k}_{s}} .$$

### Dynamic Design of Seismic Isolation Mount

Dynamic design of a seismic isolation mount is to determine a spring constant and a damping coefficient of a seismic isolation mount that are design parameters of the seismic isolation mount to satisfy the seismic safety of a switchboard and achieve a seismic effect using seismic analysis and the seismic theory of a base excitation vibration system.

### Definition of Design Matters

It is a design mater to find kₛ and cₛ that minimize f(ωₙ, ζ)=ωσ_{b,max}+(1−ω)T_{a,max}, where as a choice for design,

Xₓ(ω)|ₘₐₓ≤δ_{s,a}: maximum spring displacement

X(ω)|ₘₐₓ≤δ_{x,a}: maximum relative displacement

Tₐ(ω)|ₘₐₓ≤T_{a, a}: maximum acceleration gain

σ_{b}(ω)|ₘₐₓ≤σₐ: maximum structural safety [Formula 47]

should be satisfied, in which σ_{b}(ω)|ₘₐₓ is the maximum bending stress, σₐ is allowable stress, Tₐ(ω)|ₘₐₓ is the maximum acceleration gain, T_{a,a} is an acceleration gain limit, Xₓ(ω)|ₘₐₓ is the maximum spring displacement, δ_{s,a} is a spring displacement limit, X(ω)|ₘₐₓ is the maximum relative displacement, δ_{x,a} is displacement of a suspension device, and [symbol] is a weighting factor smaller than 1.

### Method of Determining Optimal Design Variables

### Method of Using Optimal Design Algorithm and Computer Program

In general, as a method of obtaining an optimal solution of an optimal design matter, a method that can apply an optimal algorithm based on sensitivity analysis when an objective function and design variables are continuous or analytical and that finds an optimal solution using meta-heuristic algorithms when an objective function or a design variables are discontinuous or discrete is widely used. Strong optimal design can be achieved by using such an optimal design algorithms and optimal design computer programs. However, it is actually impossible to obtain an optimal design solution without help from a computer and optimal design S/W.

### Engineer's Trial and Error Method

An engineer's trial and error method is a method that finds a design variable value that satisfies an objective function and a limit condition while changing a design variable through trial and error on the basis of mechanics theory, engineering sense, and engineering experience under a circumstance in which it is difficult to receive help of a computer and optimal design S/W, and then selects and determines excellent design on the basis of performance and cost.

Herein, a design optimization process that determines design values of a spring constant kₛ and a damping coefficient cₛ of a seismic isolation mount using the engineer's trial and error method in an optimal design matter of a switchboard supported on the seismic isolation mount defined in Formulae 47 and 48 is proposed as follows.

Step 0: Calculation of invariable design parameters

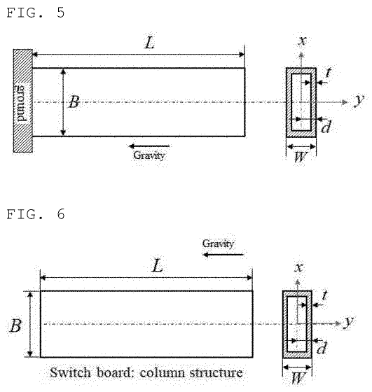

Design parameters that are required to calculate an objective function in a design process but do not change into constants during the design process are calculated. For example, when specifications of a switchboard are given as in FIG. 6, design parameters of a switchboard structure (column) need to be calculated as follows. That is,

### Area Moment of Inertia I_{y} of Switchboard Structure (Column)

$${I}_{y} = \frac{{BW}^{3} - ( B - 2 t ) {( W - 2 t )}^{3}}{12} ( {m}^{4} ) \qquad [ Formula 48 ]$$

### Spring Constant k of Switchboard Structure

$$k = \frac{3 EI}{{L}^{3}} ( N \text{/} m ) \qquad [ Formula 49 ]$$

### Damping Constant c of Switchboard Structure

c=2ζ\sqrt{mk}(Ns/m) [Formula 50]

Step 1: Selection of trial variables: trial ωₙ and trial ζ

In this case, values of trial ωₙ and trial ζ to be applied to the following steps are defined. That is, a design variable that is tried to start a design process is defined as a trial variable. In the optimal design matter of a seismic isolation mount-switchboard vibration system defined in Formula 26, since the design variables are the natural frequency ωₙ and the damping ratio ζ, the trial variables in this design process are naturally trial ωₙ and trial ζ.

For reference, the condition for achieving the seismic effect in a common base excitation vibration system is

$$r = \frac{ω}{{ω}_{n}} > \sqrt{2} ,$$

and accordingly, the natural frequency of a seismic system should satisfy a condition of

$${ω}_{n} < \frac{ω}{\sqrt{2}} .$$

However, it is recommended that a condition

$${ω}_{n} < \frac{ω}{2 \sqrt{2}}$$

is satisfied to secure a more efficient seismic effect. The frequency domain of ground acceleration in seismic analysis is usually

$$f = \frac{ω}{2 π} = 2 \text{\textasciitilde} 33 ( Hz ) ,$$

that is, ω=2π˜66π (rad/s). Accordingly, the natural frequency of a switchboard of a seismic device should be in a range of

$${ω}_{n} < \frac{ω}{2 \sqrt{2}} = π \text{\textasciitilde} 33 π ( rad \text{/} s ) or {f}_{n} < \frac{f}{\sqrt{2}} = 0.5 \text{\textasciitilde} 16.5 ( Hz ) .$$

Trial ωₙ and trial ζ are determined intuitionally from a switchboard vibration system (FIG. 3D) supported on a seismic isolation mount by referring mechanics theory and in consideration of the empirical knowledge that the damping ratio of a damping vibration system is usually about ζ=0.1 to 0.7.

It should be noted in this case that the damping coefficient of a seismic isolation mount is higher than the damping coefficient of the switchboard (structure), so the damping ratio of the seismic isolation mount-switchboard vibration system (FIG. 3D) is also higher.

Step 2: Calculation of spring constant and damping coefficient kₛ, cₛ of seismic isolation mount that are design variables.

Since the mass m of a switchboard, the spring constant k and damping coefficient c of the switchboard (structure), etc. are given as deterministic parameter values from the specifications of the switchboard, an equivalent spring constant k_{eq} and an equivalent damping coefficient c_{eq} are determined by substituting trial ωₙ and trial ζ into

$${ω}_{n} = \sqrt{\frac{{k}_{eq}}{m}} and ζ = \frac{{c}_{eq}}{2 \sqrt{{mk}_{eq}}} .$$

It should be noted in this case that _{eq} and c_{eq} are not calculated as deterministic values in the design process repeated after the second time, so they should be selected on the basis of engineering sense. That is, if corrected trial ωₙ and trial ζ are given in the repeated design process, the mass m of a vibration system is invariable in the definition of a damping ratio

$$ζ ≡ \frac{{c}_{eq}}{2 \sqrt{{mk}_{eq}}} ,$$

so when the damping ratio is changed, k_{eq} and c_{eq} should also be changed. Common engineers will select the ratios to change k_{eq} and c_{eq} on the basis of engineering knowledge and experience.

### Calculation of Equivalent Spring Constant k_{eq}

k_{eq}=mωₙ² [Formula 51]

### Calculation of Equivalent Damping Coefficient c_{eq}

c_{eq}=2ζ_{eq}\sqrt{mk_{eq}}=2mζ_{eq}ωₙ(Ns/m) [Formula 52]

### Calculation of Spring Constant kₛ of Seismic Isolation Mount

The spring constant kₛ of a seismic isolation mount is determined as follows from the definition of an equivalent spring constant

$${k}_{eq} = \frac{k \cdot {k}_{s}}{k + {k}_{s}} .$$

[Formula 53]

$${k}_{s} = \frac{k \cdot {k}_{eq}}{k - {k}_{eq}} ( N / m )$$

### Calculation of Damping Coefficient cₛ of Seismic Isolation Mount

The damping coefficient cₛ of a seismic isolation mount is determined as follows from the equivalent damping coefficient formula

$${c}_{eq} = \frac{k \cdot {c}_{s}}{k + {k}_{s}}$$

of a Zener model seismic isolation mount.

$${c}_{s} = \frac{( k + {k}_{s} ) \cdot {c}_{s}}{k} ( Ns / m ) \qquad [ Formula 54 ]$$

Step 3: Confirming whether design limit condition is satisfied

It is confirmed whether the spring constant kₛ of a seismic isolation mount and the damping coefficient cₛ of the seismic isolation mount calculated through the design processes of step 1 and step 2 satisfy the following design limit condition.

### Limit Condition of Maximum Relative Displacement Xₛ(ω)|ₘₐₓ of Seismic Isolation Mount

Whether the allowable relative displacement δ_{s,a} of a seismic isolation mount is exceeded is confirmed by obtaining the maximum relative displacement

$${X}_{s} ( ω ) {\vert}_{max} = \frac{{mA}_{g} ( {ω}_{m} )}{2 ζ {k}_{s}}$$

of the seismic isolation mount from Formula 38.

### Limit Condition of Maximum Relative Displacement X(ω)|ₘₐₓ of Switchboard

Whether the allowable relative displacement δ_{x,a} of a switchboard is exceeded is confirmed by obtaining the maximum relative displacement

$${X}_{s} ( ω ) {\vert}_{max} ≃ X ( ω ) {\vert}_{ω = {ω}_{s}} = \frac{{A}_{g} ( ω )}{2 ζ {ω}_{n}^{2}}$$

from Formula 21.

### Limit Condition of Maximum Acceleration Gain Tₐ(ω)|ₘₐₓ

Whether an allowable acceleration gain of a switchboard is exceeded is confirmed by obtaining the maximum acceleration gain

$${T}_{a} ( ω ) {\vert}_{max} = \frac{\sqrt{1 + {( 2 ζ )}^{2}}}{2 ζ}$$

of the switchboard from Formula 46.

### Limit Condition of Maximum Bending Stress σ_{b}(ω)|ₘₐₓ

Whether the allowable bending stress of a switchboard is exceeded is confirmed by obtaining the maximum bending stress

$${σ}_{b , max} = \frac{{dmkLA}_{g} ( ω )}{2 ζ I} ( \frac{1}{{k}_{eq}} - \frac{1}{{k}_{s}} )$$

that is generated in a switchboard structure (column) from Formula 43.

Step 4: End condition of design process

When all the design limit conditions are satisfied in the design process of step 3, the spring constant kₛ of the seismic isolation mount and the damping coefficient cₛ of the seismic isolation mount calculated in step 2 are determined as the final design parameters, and the design process is ended. If one or more design limit conditions are not satisfied in the design process, trial ωₙ and trial ζ are corrected such that the corresponding design conditions are satisfied, and then the design process goes back to step 1 and repeated.

The spring constant kₛ of the seismic isolation mount and the damping coefficient cₛ of the seismic isolation mount can be determined through the above design process.

Although the present disclosure has been described with reference to the exemplary embodiments illustrated in the drawings, those are merely examples and may be changed and modified into other equivalent exemplary embodiments from the present disclosure by those skilled in the art. For example, even if a ground motion is vertically generated, it is possible to perform seismic analysis using the same mathematical modeling and theoretical equations described above. However, in this case, it should be noted that vertical values should be applied to the spring constants k and k_{eq}, the damping constants c and c_{eq}, and the input ground motion u_{g}(t), and vertical tension-compressive force and corresponding tension-compressive stress should be calculated in the following process of calculating the acting force and stress in a switchboard.

Further, the method according to the present disclosure may be implemented by computer-readable codes in a computer-readable recording medium. A computer-readable recording medium includes all kinds of recording devices that store data that can be read by a computer system. The computer-readable recording medium, for example, may be a ROM, a RAM, a CD-ROM, a magnetic tape, a floppy disk, and an optical data storage device, and includes a carrier wave (for example, transmission through the internet). Further, the computer-readable recording medium may store computer-readable codes that can be executed in a distributed manner by distributed computer systems that are connected through a network.

In the terms used herein, singular forms should be understood as including plural forms unless the context clearly indicates otherwise. It will be further understood that the terms “comprises”, etc. are used to specify the presence of stated features, numbers, steps, operations, components, parts, or a combination thereof, but do not preclude the presence or addition of one or more other features, numbers, steps, operations, components, parts, or a combination thereof. Terms ‘˜er’, ‘˜unit’, ‘˜module’, ‘˜block’, etc. used herein mean the units for processing at least one function or operation and may be implemented by hardware, software, or a combination of hardware and software.

Accordingly, the embodiments and the accompanying drawings only clearly show some of the spirits included in the present disclosure. It is apparent that modifications and detailed embodiments that can be easily inferred by those skilled in the art within the scope of the present disclosure included in the specification and drawings are all included in the right range of the present disclosure.

### INDUSTRIAL APPLICABILITY

The present disclosure can be applied to seismic isolation mount for improving the seismic performance of a switchboard.

### REFERENCE SIGNS LIST

210, 212, 214: User terminal

250: Seismic isolation mount design server

260: Database

1. A system of designing a seismic isolation mount for protecting electrical equipment comprising switchboard and control panel, the system comprising:
a user terminal for inputting design constants for physical properties and dimensions of protection target equipment;
a database for storing design constants received from the user terminal; and
a seismic isolation mount design server for determining a design variable satisfying a predetermined design condition on the basis of the design constants,
wherein the seismic isolation mount design server is configured to perform:
an operation of configuring a vibration system model that models vibration of the protection target equipment in the horizontal direction;
an operation of deriving a kinetic equation of the vibration system model and normalizing the kinetic equation; and
an operation of determining a design variable for determining a spring constant and a damping coefficient of the seismic isolation mount that minimize the maximum bending stress and vibration transmissibility of the protection target equipment in the vibration system model.

2. The system of claim 1, wherein the operation of configuring a vibration system model considers
Xₓ(ω)|ₘₐₓ≤δ_{s,a}: maximum spring displacement
X(ω)|ₘₐₓ≤δ_{x,a}: maximum relative displacement
Tₐ(ω)|ₘₐₓ≤T_{a, a}: maximum acceleration gain
σ_{b}(ω)|ₘₐₓ≤σₐ: maximum structural safety
to find kₛ and cₛ that minimize f(ωₙ, ζ)=ωσ_{b,max}+(1−ω)T_{a,max}
where σ_{δ}(ω)|ₘₐₓ is the maximum bending stress, σₐ is allowable stress, Tₐ(ω)|ₘₐₓ is the maximum acceleration gain, T_{a, a} is an acceleration gain limit, Xₛ(ω)|ₘₐₓ is the maximum spring displacement, δ_{s,a} is a spring displacement limit, X(ω)|ₘₐₓ is the maximum relative displacement, δ_{x,a} is displacement of a suspension device, and [symbol] is a weighting factor smaller than 1.

3. The system of claim 2, wherein the seismic isolation mount design server, in order to configure the vibration system model, considers the protection target equipment and the seismic isolation mount as columns vibrating in the direction, and uses intensive mass, a spring constant, and damping constant of each of the protection target equipment and the seismic isolation mount.

4. The system of claim 3, wherein the seismic isolation mount design server models the kinetic equation as m\ddot{x}+c_{eq}\dot{x}+k_{eq}x=−mü_{g} to normalize the kinetic equation, and is configured to model the maximum acting force applied to the vibration system model as
$${F}_{max} ≃ {k}_{eq} X ( ω ) {\vert}_{max} = \frac{{k}_{eq} {A}_{g} ( {ω}_{m} )}{2 ζ {ω}_{n}^{2}} = \frac{{mA}_{g} ( {ω}_{n} )}{2 ζ} , where$$
$${ω}_{n} = \sqrt{\frac{{k}_{eq}}{m}}$$
is a natural frequency,
$${k}_{eq} = \frac{k \cdot {k}_{s}}{k + {k}_{s}} , ζ = \frac{{c}_{eq}}{2 \sqrt{{mk}_{eq}}}$$
is a damping ratio, A_{g}(ω) a ground acceleration spectrum,
$${c}_{eq} = \frac{k \cdot {c}_{s}}{k + {k}_{s}} ,$$
k and kₛ are spring constants of the protection target equipment and the seismic isolation mount, respectively, c and cₛ are damping constants of the protection target equipment and the seismic isolation mount, respectively, and x is displacement in the direction.

5. The system of claim 4, wherein the seismic isolation mount design server is configured to determine the spring constant and the damping coefficient of the seismic isolation mount in consideration of the maximum displacement limit values, acceleration gain limit values, and the maximum bending stress of the protection target equipment and the seismic isolation mount in order to determine the design variable.

6. The system of claim 5, wherein the maximum bending stress is obtained as
$${σ}_{b , max} = {σ}_{b} ( ω ) {\vert}_{max} = \frac{( {k}_{eq} X ( ω ) {\vert}_{ω = {ω}_{s}} L ) d}{I} = \frac{{k}_{eq} {LdA}_{g} ( {ω}_{n} )}{2 I ζ {ω}_{n}^{2}}$$
where d is the distance from the neutral axis to the outline of a cross-section of the protection target equipment, and L and I are the length and an area moment of inertia of the protection target equipment, respectively.

7. The system of claim 6, wherein the seismic isolation mount design server obtains the spring constant and the damping coefficient of the seismic isolation mount as
$${k}_{s} = \frac{k \cdot {k}_{eq}}{k - {k}_{eq}} ( N / m ) if ( k - {k}_{eq} ) > 0$$
$${k}_{s} ≃ {k}_{eq} ( N / m ) if ( k - {k}_{eq} ) \leq 0 and$$
$${c}_{s} = \frac{c \cdot {c}_{eq}}{c - {c}_{eq}} ( Ns / m ) if ( c - {c}_{eq} ) > 0$$
$${c}_{s} = ≃ {c}_{eq} ( Ns / m ) if ( c - {c}_{eq} ) \leq 0$$
in order to determine the design variable.

8. The system of claim 7, wherein the seismic isolation mount design server uses at least one of an optimal algorithm, a meta-heuristic algorithm, and an Engineer's trial and error method for the design variable to determine the design variable.

9. The system of claim 1, wherein the protection target equipment is at least one of a high-voltage switchboard, a low-voltage switchboard, a cabinet panel, a measurement control panel, and a motor control panel.
